(19) United States
(12) Patent Application Publication
(10) Pub. No.: US 2023/0421583 A1
(43) Pub. Date: Dec. 28, 2023

(54) SYSTEMS, METHODS, AND STORAGE MEDIA FOR ABSTRACTING SESSION INFORMATION FOR AN APPLICATION IN AN IDENTITY INFRASTRUCTURE

(71) Applicant: Strata Identity, Inc., Niwot, CO (US)

(72) Inventors: Eric Olden, Niwot, CO (US); Carl Eric Leach, Carlsbad, CA (US); Christopher Marie, Denver, CO (US); Todd Bailey, Port Coquitlam (CA)

(21) Appl. No.: 18/339,188

(22) Filed: Jun. 21, 2023

Related U.S. Application Data
(60) Provisional application No. 63/354,268, filed on Jun. 22, 2022.

(51) Int. Cl. H04L 9/40

(52) U.S. Cl. CPC H04L 63/1416; H04L 63/0861

(57) ABSTRACT

Systems, methods, and storage media for abstracting session information for an application in an identity infrastructure are disclosed. Exemplary implementations may: intercept, from a first computing device, a request to communicate with the application; send the request to the application from the second computing device; receive a response from the application at the second computing device; cache the one or more first cookies; remove the one or more first cookies from the response; create one or more second cookies; and transmit the response to the first computing device from the second computing device.

### CROSS-REFERENCE TO RELATED APPLICATIONS

The present application for Patent claims priority to U.S. Provisional Application No. 63/354,268, entitled “Systems, Methods, and Storage Media for Abstracting Session Information for an Application in an Identity Infrastructure,” filed Jun. 22, 2022, the contents of which are incorporated herein by reference in their entirety and for all proper purposes. The present application for Patent is also related to U.S. application Ser. Nos. 17/345,470, 17/344,585, 17/341,597, 17/329,107, 17/317,156, and 17/217,422, assigned to the assignee hereof, the contents of which are incorporated herein by reference in their entirety and for all proper purposes.

### FIELD OF THE DISCLOSURE

The present disclosure relates to systems, methods, and storage media for abstracting session information for an application in an identity infrastructure.

### BACKGROUND

Cookies are used by web applications to maintain a session with an individual user, including authentication and authorization status for accessing the application. It is fundamental to the security of the system that the cookie be attached to exactly one browser instance. However, recent exploits have broken this covenant with session cookies being extracted from browsers and sent to malicious actors who are able to access the user's application.

While there are some approaches to mitigate and prevent the exploitation of hijacked cookies, legacy applications do not widely implement these protections and must often be rewritten to add said functionality.

Thus, there is a need for a system for hardening an individual application's or set of applications' session cookie security without rewriting the application(s).

The description provided in the background section should not be assumed to be prior art merely because it is mentioned in or associated with the background section. The background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below

Broadly, aspects of the present disclosure are directed to a system (e.g., shown as system 100 in FIG. 1) that help harden security of session cookie(s) for one or more applications without rewriting said applications. In some aspects, the present disclosure helps mitigate and prevent the exploitation of hijacked cookies, which serves to enhance application security.

One aspect of the present disclosure relates to a system configured for abstracting session information for an application in an identity infrastructure. The system may include one or more hardware processors configured by machine-readable instructions. The processor(s) may be configured to intercept, from a first computing device, a request to communicate with the application. The intercepting may occur at a second computing device. The processor(s) may be configured to send the request to the application from the second computing device. The processor(s) may be configured to receive a response from the application at the second computing device. The response may include one or more first cookies. The processor(s) may be configured to cache the one or more first cookies. The processor(s) may be configured to remove the one or more first cookies from the response. The processor(s) may be configured to create one or more second cookies. The one or more second cookies may be associated with the application. The processor(s) may be configured to transmit the response to the first computing device from the second computing device. The response may include the one or more second cookies.

In some implementations of the system, the processor(s) may be configured to, after receiving a response from the application at the second computing device, detect unauthorized access of the session information by reviewing the response for any changes to information related to the first computing device.

In some implementations of the system, the information related to the first computing device may include at least one of a first computing device internet protocol or IP address and first computing device browser fingerprint information.

In some implementations of the system, the processor(s) may be configured to request additional authentication information from the first computing device after detecting unauthorized access of the session information.

In some implementations of the system, the request to communicate with the application may include original authentication information. In some implementations of the system, the additional authentication information may include at least one of (1) one or more additional factors of authentication and (2) the original authentication information provided in the request to communicate with the application.

In some implementations of the system, the processor(s) may be configured to track the session with the one or more second cookies.

In some implementations of the system, the processor(s) may be configured to replace the one or more second cookies with one of more third cookies. In some implementations of the system, the processor(s) may be configured to track the session with the one or more third cookies.

Another aspect of the present disclosure relates to a method for abstracting session information for an application in an identity infrastructure. The method may include intercepting, from a first computing device, a request to communicate with the application. The intercepting may occur at a second computing device. The method may include sending the request to the application from the second computing device. The method may include receiving a response from the application at the second computing device. The response may include one or more first cookies. The method may include caching the one or more first cookies. The method may include removing the one or more first cookies from the response. The method may include creating one or more second cookies. The one or more second cookies may be associated with the application. The method may include transmitting the response to the first computing device from the second computing device. The response may include the one or more second cookies.

In some implementations of the method, it may further include, after receiving a response from the application at the second computing device, detecting unauthorized access of the session information by reviewing the response for any changes to information related to the first computing device.

In some implementations of the method, the information related to the first computing device may include at least one of a first computing device IP address and first computing device browser fingerprint information.

In some implementations of the method, it may further include, after detecting unauthorized access of the session information, requesting additional authentication information from the first computing device.

In some implementations of the method, the request to communicate with the application may include original authentication information. In some implementations of the method, the additional authentication information may include at least one of one or more additional factors of authentication and the original authentication information provided in the request to communicate with the application.

In some implementations of the method, it may further include tracking the session with the one or more second cookies.

In some implementations of the method, it may include replacing the one or more second cookies with one of more third cookies. In some implementations of the method, it may include tracking the session with the one or more third cookies.

Yet another aspect of the present disclosure relates to a non-transient computer-readable storage medium having instructions embodied thereon, the instructions being executable by one or more processors to perform a method for abstracting session information for an application in an identity infrastructure. The method may include intercepting, from a first computing device, a request to communicate with the application. The intercepting may occur at a second computing device. The method may include sending the request to the application from the second computing device. The method may include receiving a response from the application at the second computing device. The response may include one or more first cookies. The method may include caching the one or more first cookies. The method may include removing the one or more first cookies from the response. The method may include creating one or more second cookies. The one or more second cookies may be associated with the application. The method may include transmitting the response to the first computing device from the second computing device. The response may include the one or more second cookies.

In some implementations of the computer-readable storage medium, the method may further include, after receiving a response from the application at the second computing device, detecting unauthorized access of the session information by reviewing the response for any changes to information related to the first computing device.

In some implementations of the computer-readable storage medium, the information related to the first computing device may include at least one of a first computing device IP address and first computing device browser fingerprint information.

In some implementations of the computer-readable storage medium, the method may further include requesting additional authentication information from the first computing device after detecting unauthorized access of the session information.

In some implementations of the computer-readable storage medium, the request to communicate with the application may include original authentication information (or simply, authentication information). In some implementations of the computer-readable storage medium, the additional authentication information may include at least one of one or more additional factors of authentication and the original authentication information provided in the request to 5I communicate with the application.

In some implementations of the computer-readable storage medium, the method may further include tracking the session with the one or more second cookies.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for abstracting session information for an application in an identity infrastructure, in accordance with various aspects of the disclosure.

FIG. 2A illustrates a method for abstracting session information for an application in an identity infrastructure, in accordance with various aspects of the disclosure.

FIG. 2B illustrates a method for abstracting session information for an application in an identity infrastructure, in accordance with various aspects of the disclosure.

FIG. 2C illustrates a method for abstracting session information for an application in an identity infrastructure, in accordance with various aspects of the disclosure.

FIG. 2D illustrates a method for abstracting session information for an application in an identity infrastructure, in accordance with various aspects of the disclosure.

FIG. 2E illustrates a method for abstracting session information for an application in an identity infrastructure, in accordance with various aspects of the disclosure.

FIG. 3 illustrates a diagrammatic representation of a computer system configured for abstracting session information for an application in an identity infrastructure, in accordance with various aspects of the disclosure.

FIG. 4A illustrates a swim diagram representation of a method for abstracting session information for an application in an identity infrastructure, in accordance with various aspects of the disclosure.

FIG. 4B illustrates a swim diagram representation of a method for abstracting session information for an application in an identity infrastructure, in accordance with various aspects of the disclosure.

FIG. 5 illustrates an identity infrastructure having a cookie bastion module configured for abstracting session information for an application in the identity infrastructure, in accordance with various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are typically not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. It should be understood that these terms are employed to provide a clear description of an embodiment of the present disclosure, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more embodiments of the present disclosure include general-purpose digital computers or other similar devices. In all cases the distinction between the method of operations in operating a computer and the method of computation itself should be recognized. One or more embodiments of present disclosure relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, where some aspects of the algorithm are performed by the circuitry itself rather than a result of an instruction.

Some embodiments of the present disclosure rely on an apparatus for performing disclosed operations. This apparatus may be specifically constructed for the required purposes, or it may comprise a general-purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. Some non-limiting examples of structures for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that the client and server each perform distinct, but complementary functions to accomplish a task or provide a service. The client and server accomplish this by exchanging data, messages, and/or state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

### Definitions and Terminology Used in the Disclosure

For the purposes of this disclosure, identity data may refer to individual users' data, including their credentials and attributes. For instance, identity data may include one or more of a user identity (e.g., first and/or last name of a user), a user credential (e.g., username, password, password authentication token, etc., that are bound to the user), and a user attribute (e.g., email address, phone number, residential address, job title, department, employee ID, etc.) for each of one or more individual users of one or more identity domains or identity providers.

An identity session (also referred to herein as a “session”) may refer to an established set of identity data (e.g., identity data accepted by the identity infrastructure to access a resource, such as an application) that represents a user interacting with the identity infrastructure. In some cases, an identity session may be established by authenticating a user (e.g., by a user proving their identity through a mechanism such as username and password and/or biometrics, such as fingerprint, iris scan, voice recognition, etc.) and maintaining this session state (e.g., authenticated state) for some established period of time or until the user logs out or their access rights are otherwise suspended. In some cases, an identity session may refer to a logical construct, for instance, based on a user's identity, that establishes persistence across resource access (e.g., file access, app access) and/or page views (e.g., hypertext transfer protocol (HTTP) pages). It is contemplated that a “resource” may also refer to “page views”. For example, HTTP is a stateless protocol, which means that when a user requests a particular webpage or resource from a server, and subsequently requests another webpage or resource from the same server, the server treats the user as a new “requestor” each time. In some examples, a session state refers to a feature that allows an identity domain or provider to remember the user by keeping a temporary record of identity data associated with the user. In some cases, each identity session may be assigned a unique identifier (or session ID) and this session ID may be used to store and retrieve a session state (or an application's working set of data) before and after each page view (e.g., HTTP page view). The application's working set of data may refer to information associated with one or more page views (e.g., items in a shopping cart for an online shopping or e-commerce website). In some cases, the information associated with the session, such as the session ID, may be stored on the server from which the user is requesting the webpage or resource. Additionally, or alternatively, the session ID may be stored on a different computing device such as a user device (e.g., laptop, smartphone, etc.) from which the user is accessing the resource. In some cases, an identity session may be established by authenticating a user and maintaining a session state for at least a threshold or an established period of time (e.g., 1 minute, 30 seconds, 5 minutes, etc.). In some cases, an identity session may also constitute a set of permissions granted to the user (e.g., for accessing resources, such as protected resources accessible to only certain users, in the identity infrastructure) and/or role information associated with the user. In some embodiments, the role information may be different from the user attribute. For instance, multiple users may be associated with the same or similar role information but may have different user attributes. In one example, users having similar designations or seniority levels in an organization (e.g., managers, managing directors, staff engineers, etc.) may be associated with the same or similar role information, while having different user attributes.

Identity metadata may be used herein to refer to information pertaining to how identity is managed and coordinated. Identity metadata may include password rules, such as, but not limited to password length or a requirement that the password must contain one capital letter, one number, one symbol and/or cannot be the same as a previous password. Identity metadata may also include authorization policies, such as, but not limited to, a policy which states that user must be in the administrator group to access a resource, a user must be logged in from a US-based IP address, and/or a user may only access resources during business hours (e.g., 9 AM to 5 PM). Additionally, or alternatively, identity metadata may also include a trust policy and network locations for identity domain elements of one or more identity domains (i.e., identity providers). The identity metadata may further include one or more of: the enumeration of identity infrastructure elements and their network location and configuration, identity policies such as authorization or authentication rules and mechanisms, and identity session structure and content.

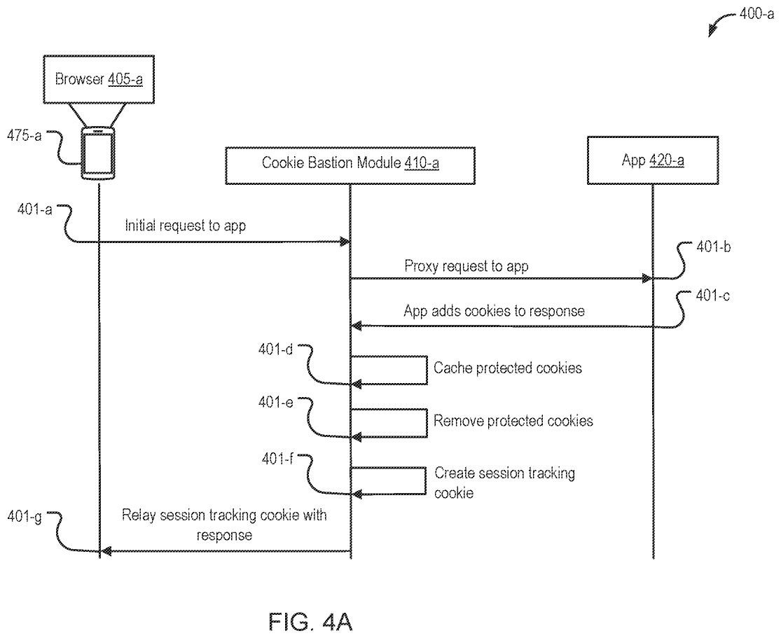

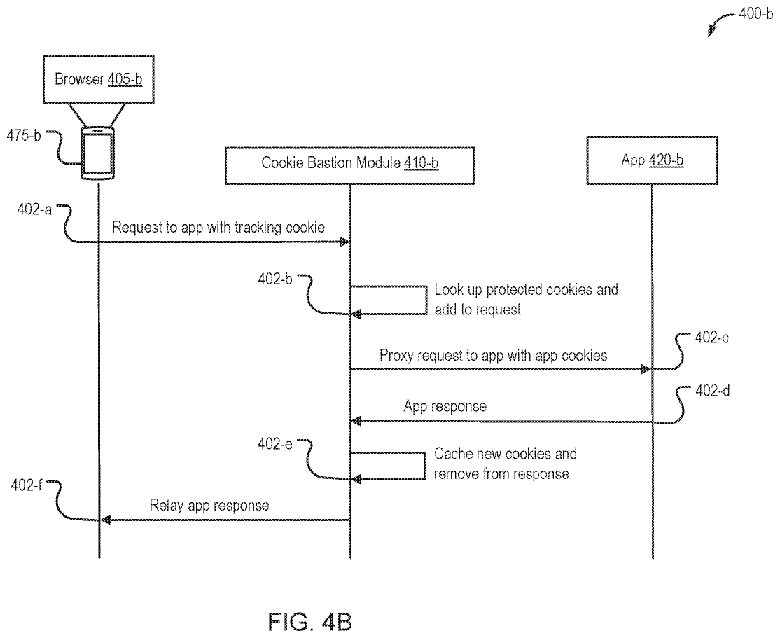

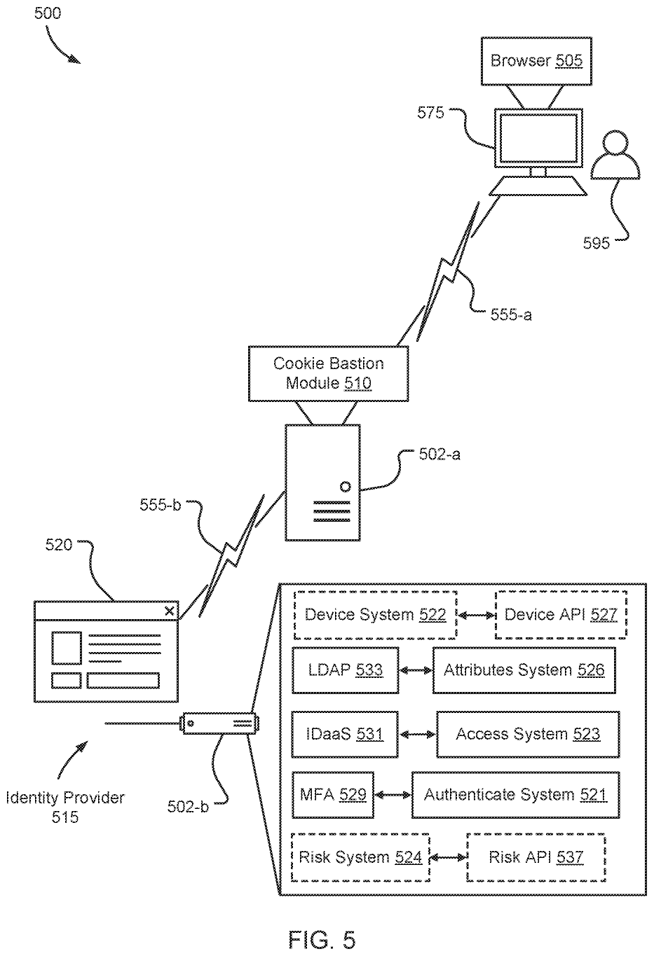

In some examples, identity sessions may comprise timestamps for when a session was initiated, the maximum lifetime of a session, how long a session should last for an idle user, an opaque user identifier (e.g., a type of user identifier that does not reveal the user's identity and may comprise a random string or number), a reference to a session identifier (potentially optional, e.g., if maintained centrally), a reference to a requested resource, one or more claims about the user (which may comprise identity attributes), one or more “scopes”, and/or an enumeration of privileges the user has for the requested resource. In some examples, sessions may be maintained in browser cookies, JavaScript Object Notation (JSON) objects that are passed between different endpoints, server caches, or databases. In some cases, scopes may be used to define the specific actions that are permitted to be performed on behalf of a user, an application, etc. When a user agent (e.g., web browser, such as browser 405-a in FIG. 4A) requests permission to access a protected resource or application (e.g., app 420-a) through an authorization server, a scope parameter may be provided to specify what access is needed and the authorization server may use the scope parameter to respond with the access that is actually granted (e.g., the granted access may be different from what was requested). In some examples, this process may comprise the authorization server (e.g., access system 523 seen in FIG. 5) generating an access token comprising one or more scopes based on evaluating the user authentication data and/or scope parameters. In some cases, the access token comprises a string of random characters that enables the protected resource (e.g., app 520) to verify whether incoming requests may be granted access to the protected resource. For instance, the access token may be based in part on the username/password credentials received from the user (e.g., user 595) during login. In some cases, the access token serves as a key comprising a collection of metadata (e.g., information pertaining to an authorization policy for the user).

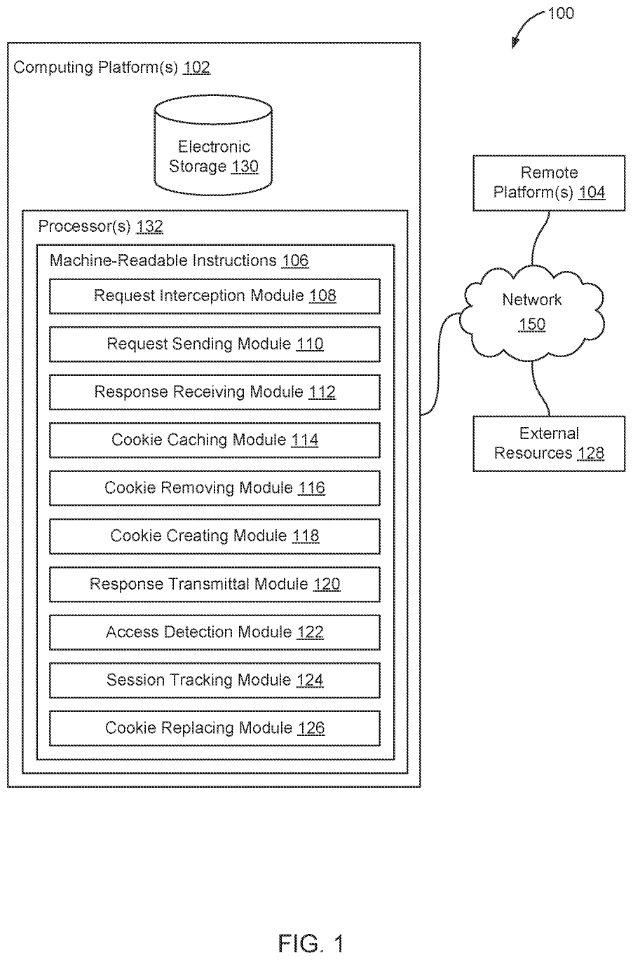

An identity domain (or identity provider, such as identity provider 515) refers to a computing system for managing one or more of users and roles, integration standards, external identities (e.g., identities not associated with the identity domain), and secure application integration using, for instance, an authentication scheme (e.g., Single Sign-On (SSO)) and/or an authorization protocol (e.g., a set of rules that allows a third-party website or application to access a user's data without the user needing to share login credentials). Application integration, as used herein, refers to a mechanism for supporting interactions between an application or protected resource associated with a first identity domain and users associated with a second different identity domain. As an example, an enterprise may have developed an app for its customer or enterprise partner, where the app may be secured by a first identity domain. Further, the enterprise partner may already manage one or more identities on other identity domains, such as a second identity domain. In such cases, the enterprise may integrate their app with the second identity domain, which may allow users associated with the second identity domain to seamlessly interact with their app without creating another identity (e.g., in the first identity domain) to access the app. In another case, an enterprise may migrate users from a legacy identity domain to a new identity domain, while still keeping the legacy identity domain for controlling access to an application. In such cases, users attempting to access the application may login with the new identity domain, following which an intermediary/proxy updates a datastore utilized by the app to grant or deny access to its resources, further described below in relation to FIGS. 1-5. In some cases, this datastore is associated with the legacy identity domain.

In some cases, integration of identities and applications may be performed using one of numerous methods, such as manual identity administration (e.g., manually adding users from the second identity domain into the first identity domain), utilizing existing identity solutions (e.g., allowing users to sign in using their GOOGLE or MICROSOFT credentials, provided by Alphabet, Inc., of Mountain View, CA, and Microsoft Corp., of Redmond, WA, respectively), and/or federation (e.g., enterprise and customer/enterprise partner mutually agree to allow the enterprise partner users to use their own identities to access the app provided by the enterprise). In some cases, identity federation may comprise enforcing common identity standards and protocols to coordinate and manage user identities between different identity providers or identity domains, applications, etc., across an identity infrastructure.

There exist numerous identity and access management (IAM) standards (also referred to as integration standards) for managing access. In some cases, these IAM standards are “open” standards, that is, they are publicly available and associated with one or more rights to use. In some cases, these IAM standards are integrated (e.g., unified) and used across a plurality of applications, devices, and/or users. Some non-limiting examples of IAM standards include Security Assertion Markup Language (SAML) used to send authorization messages between trusted partners or entities, OpenID Connect (OIDC), Web Services Trust (WS-Trust), WS-Federation, and OAuth. SAML defines an XML framework for exchanging security assertions among security authorities and facilitates interoperability across different vendor platforms that provide authentication and/or authorization services. In some circumstances, OAuth may enable a user's account information to be used by third-party services, such as FACEBOOK provided by Meta Platforms, Inc., of Menlo Park, CA, without exposing the user's password. In some examples, an identity domain (or identity provider) controls the authentication and authorization of the users who can sign into a service (e.g., a cloud service), and what features they can access in relation to the service. For example, a cloud service (e.g., Database Cloud Service and Infrastructure as a Service (IaaS)) may be associated with an identity domain. Multiple services may be associated with a single identity domain or provider to share user definitions and authentication rules, for instance. In some cases, users associated with an identity domain may be granted different levels of access (or authorization) to each service (e.g., cloud service) associated with the identity domain. For instance, a first user (e.g., a system administrator) may be provided both read and write access, while another user (e.g., accountant) may only be provided read access. Thus, in some aspects, an identity domain or provider is a self-contained realm with consistent identity data and identity metadata throughout. Some non-limiting examples of an identity domain include an Active Directory (AD) domain or an OKTA account for a single company. It should be noted that other identity domains known in the art may be contemplated in different embodiments.

A trust relationship refers to a logical link established between two entities (e.g., a user and an identity domain, two identity domains, etc.), where one of the entities may be referred to as a trusting domain (e.g., a first identity domain) while the other may be referred to as a trusted domain (e.g., a second identity domain). When a trust relationship is in place, the trusting domain may honor, for instance, a login authentication associated with the trusted domain. In some circumstances, trust relationships may be necessary for identity sessions to be accepted by the protected resource (e.g., application). Trust relationships may be a way to establish the validity of identity sessions and prevent spoofing of an identity session. In some cases, trust relationships may be established via a signature generated from a private key and validated using an associated public key.

Public key cryptography (also known as asymmetric cryptography) refers to an encryption technique where two parties (e.g., a user and an identity domain/provider, a user and a protected resource) may each be assigned two keys—a public key and a private key. Numerous cryptographic tools and modules exist for generating public/private key pairs. One non-limiting example of such a tool is OpenSSL provided by TheOpenSSL Project. OpenSSL is an open-source command line tool that is used for Transport Layer Security (TLS) and Secure Socket Layer (SSL) protocols and may be used to generate public/private keys, install SSL/TLS certificates, and identity certificate information. Other types of commercial and/or open-source tools for generating public and private keys are contemplated in different embodiments. In some cases, the two keys for a respective party may be connected and may comprise two large prime numbers (e.g., 100 digits long, 150 digits long, etc.) with certain mathematical properties. For instance, two random n-bit (e.g., 512-bit, 1024-bit, etc.) prime numbers may be generated and multiplied together to create a modulus (N), where the value N is part of the public and private key. The public key may be shareable and may allow a receiving entity to receive messages from other entities. Further, the receiving entity may decrypt the message or dataflow using their private key. In such cases, a receiving entity may decode a message encoded by a transmitting entity (i.e., using the receiving entity's public key) by using their private key (i.e., the receiving entity's private key). In some cases, a user may be authenticated using their login credentials and a trusted third party (e.g., a Certification Authority (CA)) may prove a link between the public key of the user and the user's identity. For instance, the CA may also be associated with a public key and a private key and may sign a certificate using their private key. The identity domain or protected resource may use the CA's public key to determine the user's public key (e.g., embedded within the certificate) and verify the user (i.e., confirm the user's identity by verifying who they say they are). In some cases, any entity (e.g., protected resource, another user, etc.) with the CA's public key may decrypt the certificate to identify the user's public key.

In some cases, public/private key pairs may also be used to decrypt and verify assertions between different identity domain and/or identity infrastructure elements. Each receiving entity possessing a public key associated with a transmitting entity may be able to read (e.g., decrypt) a message that has been signed using a corresponding private key of the transmitting entity and confirm that the original contents of the message have not been altered, for instance. Or, in one non-limiting example, an identity domain element may use its private key to sign a cookie associated with an identity session. In such cases, one or more protected resources or applications that trust and rely on the cookie to grant user access to the protected resource may utilize the public key in the identity session to decrypt and verify the signature, thereby enabling access to the protected resource.

In other cases, trust relationships may involve TLS combined with a Domain Name System (DNS) to confirm that traffic is routed to the expected element and not subject to interception by a rogue party (e.g., man-in-the-middle attack). As an example, two servers may connect together over a network and communicate with each other, where their communications may be secured using TLS. In some cases, TLS may involve the use of a specific protocol to enable the servers to establish their identity with each other. Similarly, communication(s) between an identity domain/provider, protected resource, etc., may be secured using TLS. In some cases, a DNS routing a request to a host (e.g., a first server) may issue a certificate to the requesting party (e.g., a second server, a user agent, etc.) to prove that the DNS routed the request to the correct host. In some cases, the certificate may be signed using a private key associated with the DNS and may comprise a public key associated with the host server. The requesting party may decrypt the certificate (e.g., using the public key associated with the DNS) and retrieve the public key of the host embedded within the certificate, which may allow the requesting party to confirm that the request was routed to the expected element. In other cases, the host server may issue a certificate and sign it using their private key. The DNS or the host may further relay the certificate to the requesting party. After decryption, the requesting party may confirm the identity of the host that received their request.

In some examples, an intermediary (e.g., an orchestrating agent or orchestrator) may direct the flow of identity data through the identity infrastructure. In some embodiments, orchestrating agents, may be installed and placed as proxies within the flow of identity data (e.g., authentication and authorization requests, managing users, setting and reading user attributes) and identity metadata (e.g., setting, editing, and reading access policies, password rules, data locations, rules controlling user administration tasks and the hierarchy delegation of those tasks, rules for assigning user memberships in groups, roles, etc., and rules or policies to determine the assignment of accounts to users) of the existing system or identity infrastructure. In another example, a cookie bastion module (e.g., cookie bastion module 410-a, cookie bastion module 510) may serve as the intermediary, further described below in relation to FIGS. 1-5.

As used herein, the term “protected resource” may refer to an element or application of the identity infrastructure that assesses or evaluates the identity data (e.g., information provided by a user to access the protected resource such as, but not limited to, a username, password, user attribute, unique identifier, unique pin, and biometric information such as, but not limited to a fingerprint, iris scan, and voice input, and other information known in the art) in order to make access and control decisions about its resources and/or data. One non-limiting example of a protected resource may include the app 520 in FIG. 5. In other words, a protected resource may be aware about the identity data needed to access it. In some circumstances, the protected resource may use the identity session and/or the identity data in deciding to allow access to its data. In some embodiments, the protected resource may only allow restricted or partial access based on evaluating the identity data. As an example, a protected resource may expect a header or a cookie for access to the protected resource, while another protected resource may merely grant access upon a user arriving at that protected resource. Thus, each protected resource may be aware of the mechanism by which it may be provided an identity session by its associated identity domain. In some aspects, the protected resources are coupled to the identity domain based on their reliance on identity session(s) and their particular formats and security constraints (i.e., identity data and/or identity metadata formats and constraints).

In some cases, a header/cookie may be passed in a token, such as an authentication token or an access token. The authentication token may be generated and assigned to a user once the user is authenticated. Further, a certificate (e.g., a Public Key Infrastructure (PKI) certificate, such as a SSL certificate) linked to the authentication token and representing a valid identity session may be issued to the user. In some cases, the certificate may be issued by a third party, such as a CA and may include the user's public key, a name, and any other applicable information. The certificate may serve as an attestation by the CA that the user is who they claim to be. For instance, the CA may sign a data structure that contains the user's public key and name, thus binding the user's public key to their name. Further, the certificate may be encrypted by the CA using a combination of the CA's public and private keys. Any entity (e.g., protected resource or app, another user, another identity domain, etc.) with access to the CA's public key may verify the certificate (i.e., that the certificate is issued by a trusted CA) and/or the claim made in the certificate (i.e., the user is associated with the user's public key). The user may utilize this certificate for interactions with the app, for instance.

In some cases, authorization may comprise using attribute information associated with the token issued to the user during authentication and comparing said information to access control rules for the protected resource (e.g., app 520 seen in FIG. 5). If the rule permits the user to access the protected resource, the authorization is successful, and the user is granted access to the protected resource. In some other cases, access tokens may be utilized, for instance, if an identity domain/provider or protected resource does not support the use of certificates and authentication tokens. In such cases, an access token may be issued by a server, such as an authorization server (e.g., access system 523) once the user identity data, access control rules, etc., is verified. In other words, the access token may serve as a proof that the user is authorized for access. This access token may be sent in an authorization header, such as an HTTP authorization header, and may be used to establish user identity and authorization. In some cases, the protected resource (e.g., app 520) or identity domain/provider (e.g., identity provider 515) may validate the token, for instance, via a call to one or more of the authentication server (e.g., authenticate system 521) and authorization server (e.g., access system 523), or using a public key corresponding to a private key with which the authentication and/or authorization server signed the access token. Alternatively, in some circumstances, anyone (e.g., authorized user, rogue user) holding the access token may gain access to the protected resource. To alleviate such issues, communication of the access token may be secured via TLS. Centralized validation of access tokens may also mitigate the chances of a rogue user gaining access to a protected resource (i.e., man-in-the middle attack). Some non-limiting examples of tokens (e.g., access tokens, authentication tokens) may comprise bearer tokens, hash-based authentication code (HMAC) tokens, and RSA-SHA 1 tokens using RSA private/public keypairs. In some cases, a token may comprise one or more of unique string values, hashed values, a cryptographic hash function and a secret cryptographic key, attributes information, etc., issued by an authentication server (e.g., authenticate system 521).

The identity infrastructure, such as identity infrastructure 500, may include one or more identity domains (or identity providers) and one or more identity infrastructure elements. The one or more identity domains (e.g., identity domain or provider 515) may further comprise one or more identity domain elements, where the one or more identity domain elements may comprise hardware (e.g., servers, computing devices or platforms, etc.), software (e.g., a cloud service), or a combination thereof. For example, in FIG. 5, the identity provider 515 comprises at least one server 502-b and app(s) 520. The identity provider 515 further comprises an attributes system 526, an access system 523, an authenticate system 521, a device system 522, and a risk system 524. In some cases, the attributes system 526, the access system 523, and/or the authenticate system 521 may be embodied in hardware, software, or a combination thereof. By way of non-limiting example, the one or more identity infrastructure elements installed in the identity infrastructure may include one or more of servers, routers, datastores, identity stores comprising one or more databases of authentication information, policy enforcement points for enforcing authorization rules (e.g., shown as access system 523 in FIG. 5), authentication points for determining user identity (e.g., shown as authenticate system 521 in FIG. 5), proxy devices (e.g., a cookie bastion module 510 installed on server 502-a), policy decision points for evaluating authorization rules based at least in part on identity session attributes, and protected resources (e.g., app(s) 520). In some instances, one or more of the device system 522 and the risk system 524 may be optional (shown as optional by the dashed lines).

In some examples, a policy decision point (PDP) is a system entity or component of a policy-based access control system that is configured to make authorization decisions for itself or alternatively, for other system entities that request such decisions. For instance, a PDP may determine whether or not to authorize a user's request based on available information (e.g., attributes, such as identity session attributes) and/or applicable security policies. In some cases, a PDP may examine a request to access a resource (e.g., an application or app, such as a mobile app, web-based app, etc.) and compare said request to a policy that applies to requests for accessing that resource (i.e., to determine whether the requestor, such as a user, should be granted access). Additionally, or alternatively, the identity infrastructure 500 may comprise at least one authorizing agent, also referred to as an enforcing agent, for interpreting identity session information and evaluating access rules. In other words, the authorizing or enforcing agent may enforce access control for app(s) 520 in the identity infrastructure 500. In some embodiments, the identity session and identity data may be associated with the identity session information. Further, the authorizing or enforcing agents may be realized using hardware, firmware, software or a combination thereof.

In some cases, an identity provider 515 (or identity domain 515) may refer to a construct for managing one or more of users and roles, integration standards, external identities, and secure application integration through SSO policies. In some aspects, the identity provider 515 may control the authentication and authorization of users who can sign into a service, and the features they can access in relation to the service. In some examples, the service may be a cloud service. In other cases, the service may be an on-premises service. In some circumstances, the identity infrastructure for an enterprise may comprise multiple identity domains/providers, and each identity domain may comprise multiple services. In other words, users of different identity domains/providers may be granted access to different services, applications, resources, etc., based on the services associated with each identity provider. Furthermore, users in an identity provider may also be granted different levels of access to each service associated with the identity provider. As used herein, the terms “identity domains”, “identity providers”, and “identity systems” may be used interchangeably throughout the disclosure.

In some cases, an enterprise or organization may utilize one or more identity providers, such as an on-premises identity provider and one or more cloud-based identity providers. In such cases, the enterprise may also need to manage identity (e.g., of their employees, their customers, etc.) in multiple locations (e.g., geographic locations, network locations, or a combination). Businesses are increasingly using multiple cloud services (e.g., Amazon Web Services (AWS) provided by Amazon, Inc., of Seattle, WA, Azure AD provided by Microsoft, Corp., of Redmond, WA, Google Cloud Platform (GCP) provided by Alphabet, Inc., of Mountain View, CA), each of which use unique, built-in identity systems. Further, a business or enterprise may wish to migrate applications and/or identity information to the cloud with minimal changes to the apps, how users interact with the apps, etc. For instance, an enterprise using a legacy identity system (e.g., not cloud based) may wish to migrate user accounts from the legacy identity system to the cloud-based identity system. However, the legacy identity system may be currently used to secure access to an application (e.g., an on-premises hosted application). According to aspects of this disclosure, an enterprise may migrate their user identities (or identity information) from the legacy identity system/provider to another identity system (e.g., cloud-based identity system), such that user access to the application is now provided by the other identity system, while at the same time minimizing user disruption and/or changes to user experience (i.e., how users interact with the application), as further described below. In some aspects, the present disclosure also helps minimize the cost, time, and/or resources associated with rewriting the application to ensure compatibility with the new identity system.

### EMBODIMENTS OF THE DISCLOSURE

Turning now to FIG. 1, which illustrates a system 100 configured for abstracting session information for an application in an identity infrastructure, in accordance with various aspects of the disclosure. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104. In some examples, the terms “remote platform”, “user device”, or “user equipment” may be used interchangeably throughout the disclosure. One non-limiting example of a user equipment (UE) includes UE 575 described below in relation to FIG. 5.

Computing platform(s) 102 may be configured by machine-readable instructions 106. Machine-readable instructions 106 may include one or more instruction modules. The instruction modules may include computer program modules. The instruction modules may include one or more of request interception module 108, request sending module 110, response receiving module 112, cookie caching module 114, cookie removing module 116, cookie creating module 118, response transmittal module 120, access detection module 122, session tracking module 124, cookie replacing module 126, and/or other instruction modules.

Request interception module 108 may be configured to intercept, from a first computing device, a request to communicate with the application. The intercepting may occur at a second computing device. For example, in FIG. 4A, a cookie bastion module 410-a (i.e., second computing device) intercepts a request to access an app 420-a, where the request is transmitted from a UE 475-a (i.e., first computing device). In some cases, the cookie bastion module may be hosted or executed on a server. As shown in FIG. 5, a cookie bastion module 510 is hosted or executed on a server 502-a.

Request sending module 110 may be configured to send the request to the application from the second computing device. As shown in FIG. 4A, the cookie bastion module 410-a proxies the request to the app 420-a.

Response receiving module 112 may be configured to receive a response from the application at the second computing device. The response may include one or more first cookies. As shown in FIG. 4, the app 420-a transmits a response to the cookie bastion module 410-a, where the response includes one or more first cookies.

Response receiving module 112 may be configured to, after receiving a response from the application at the second computing device, detect unauthorized access of the session information by reviewing the response for any changes to information related to the first computing device (e.g., UE 475-a, UE 475-b). The information related to the first computing device may include at least one of an internet protocol (IP) address associated with the first computing device and browser fingerprint information for the first computing device. In some instances, the UE comprises a browser, such as browser 405-a in FIG. 4A. Additionally, the browser 405-a is linked or associated with unique information specific to the browser, herein referred to as browser fingerprint information. The browser fingerprint information may include information passed through hypertext transfer protocol (HTTP) headers such as a user's operating system (OS) version, web browser version, and/or preferred language, to name a few non-limiting examples.

Cookie caching module 114 may be configured to cache the one or more first cookies. For example, at operation 401-d in FIG. 4A, the cookie bastion module 410-a caches the one or more first cookies (e.g., protected cookies) received in the response.

Cookie removing module 116 may be configured to remove the one or more first cookies from the response. For example, at operation 401-d in FIG. 4A, the cookie bastion module 410-a removes the one or more first cookies (e.g., protected cookies) received in the response.

Cookie creating module 118 may be configured to create one or more second cookies. For example, at operation 401-e in FIG. 4A, the cookie bastion module 410-a creates one or more session tracking cookies (i.e., second cookie(s)). In some examples, the one or more second cookies may be replaced with the one or more third cookies upon at least one of (1) a time associated with a most recent request of the plurality of requests to communicate with the application exceeds an identified time period, and (2) the most recent request of the plurality of requests to communicate with the application exceeds an identified total number of requests. In some cases, the one or more second cookies (e.g., session tracking cookies in FIG. 4A) are associated with the application (e.g., app 420-a).

Response transmittal module 120 may be configured to transmit the response to the first computing device from the second computing device. The response may include the one or more second cookies. For example, at operation 401-f in FIG. 4A, the cookie bastion module 410-a relays the session tracking cookie(s) along with the response to the UE 475-a.

Access detection module 122 may be configured to request additional authentication information from the first computing device (e.g., UE 475-a, UE 475-b) after detecting unauthorized access of the session information. The additional authentication information may include (1) one or more additional factors of authentication (e.g., MFA), (2) the original authentication information provided in the request to communicate with the application, or both (1) and (2). In some cases, the additional authentication information may also include, for instance, information required by an MFA provider, where the information required by the MFA provider may include a time-based one time password (TOTP) passcode or token, and a passkey from a paired user device, to name two non-limiting examples.

Session tracking module 124 may be configured to track the session with the one or more second cookies. Additionally, or alternatively, the session tracking module 124 may be configured to track the session with the one or more third cookies. For example, the session tracking module 124 may be configured to track the session with the one or more third cookies in the event that the one or more second cookies have been replaced with the one or more third cookies.

Cookie replacing module 126 may be configured to replace the one or more second cookies with one of more third cookies. For example, at operations 401-d and 401-e in FIG. 4A, the cookie bastion module 410-a caches and removes the one or more second cookies (e.g., protected cookies) from the response removed from the app 420-a and replaces them with one or more third cookies (e.g., session tracking cookie(s)) before relaying the third cookie(s) and the response to the UE 475-a. In another example, at operation 402-e in FIG. 4B, the cookie bastion module 410-b caches the new cookies received from the app 420-b before forwarding the app response to the UE 475-b.

In some implementations, the request to communicate with the application (e.g., app 420-a in FIG. 4A) may include original authentication information. In some implementations, the request to communicate with the application may include a plurality of requests to communicate with the application.

In some implementations, computing platform(s) 102, remote platform(s) 104, and/or external resources 128 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which computing platform(s) 102, remote platform(s) 104, and/or external resources 128 may be operatively linked via some other communication media.

A given remote platform 104 may include one or more processors configured to execute computer program modules. The computer program modules may be configured to enable an expert or user associated with the given remote platform 104 to interface with system 100 and/or external resources 128, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some implementations, some or all of the functionality attributed herein to external resources 128 may be provided by resources included in system 100.

Computing platform(s) 102 may include electronic storage 130, one or more processors 132, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 130 may comprise non-transitory storage media that electronically stores information. The electronic storage media of electronic storage 130 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from computing platform(s) 102, information received from remote platform(s) 104, and/or other information that enables computing platform(s) 102 to function as described herein.

Processor(s) 132 may be configured to provide information processing capabilities in computing platform(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute modules 108, 110, 112, 114, 116, 118, 120, 122, 124, and/or 126, and/or other modules (e.g., cookie bastion modules 410-a, 410-b, 32I and/or 510). Processor(s) 132 may be configured to execute modules 108, 110, 112, 114, 116, 118, 120, 122, 124, and/or 126, and/or other modules by software; hardware; firmware; some combination of software, hardware, and/or firmware; and/or other mechanisms for configuring processing capabilities on processor(s) 132. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, and/or 126 are illustrated in FIG. 1 as being implemented within a single processing unit, in implementations in which processor(s) 132 includes multiple processing units, one or more of modules 108, 110, 112, 114, 116, 118, 120, 122, 124, and/or 126 may be implemented remotely from the other modules. The description of the functionality provided by the different modules 108, 110, 112, 114, 116, 118, 120, 122, 124, and/or 126 described below is for illustrative purposes, and is not intended to be limiting, as any of modules 108, 110, 112, 114, 116, 118, 120, 122, 124, and/or 126 may provide more or less functionality than is described. For example, one or more of modules 108, 110, 112, 114, 116, 118, 120, 122, 124, and/or 126 may be eliminated, and some or all of its functionality may be provided by other ones of modules 108, 110, 112, 114, 116, 118, 120, 122, 124, and/or 126. As another example, processor(s) 132 may be configured to execute one or more additional modules that may perform some or all of the functionality attributed below to one of modules 108, 110, 112, 114, 116, 118, 120, 122, 124, and/or 126.

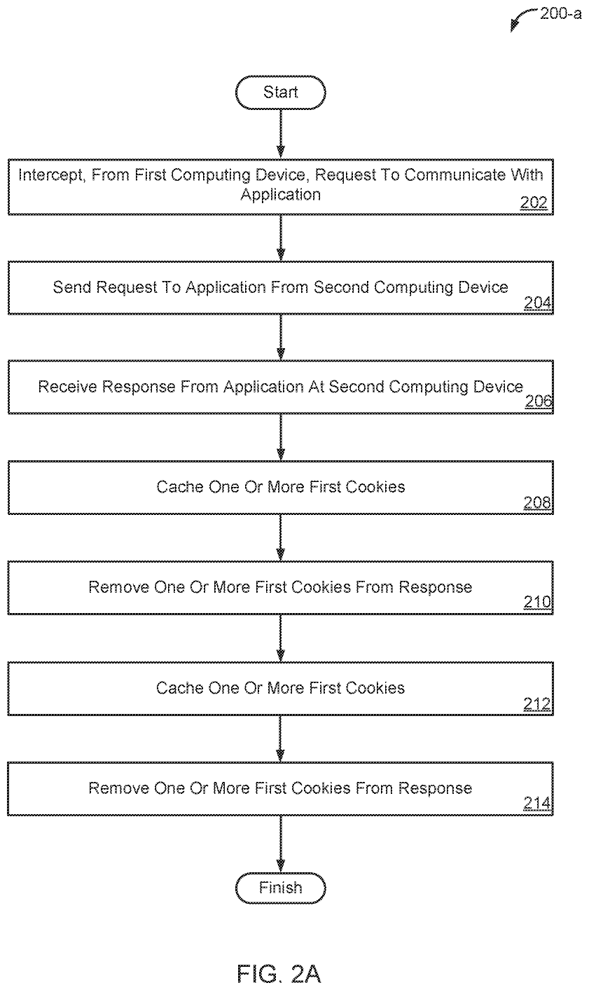

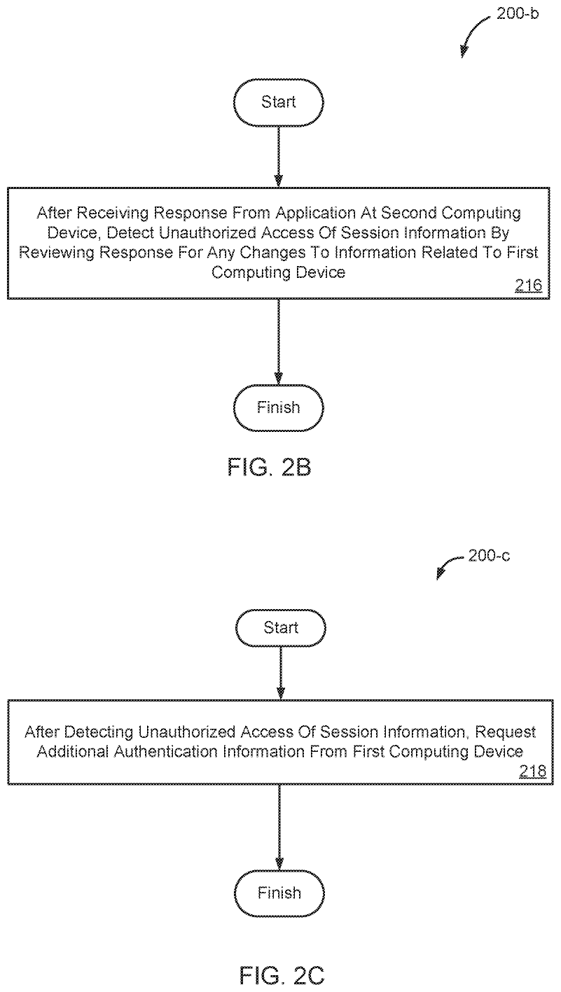

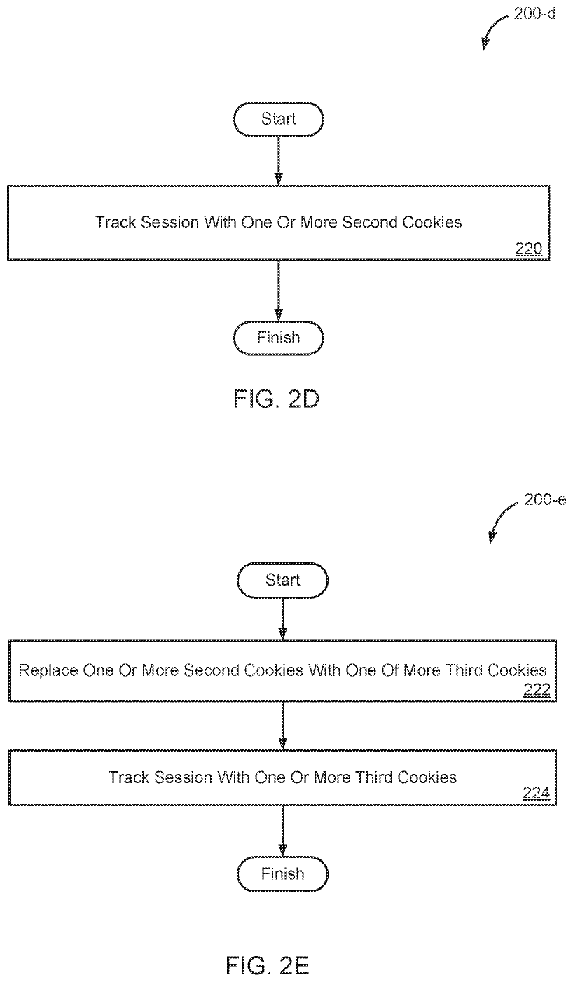

FIGS. 2A, 2B, 2C, 2D, and 2E illustrate method(s) 200 (e.g., methods 200-a, 200-b, 200-c, 200-d, and 200-e) for abstracting session information for an application in an identity infrastructure, in accordance with various aspects of the disclosure. The operations of method(s) 200 presented below are intended to be illustrative. In some implementations, method(s) 200 may be accomplished with one or more additional operations not described, and/or without one or more of the operations discussed. Additionally, the order in which the operations of method(s) 200 are illustrated in FIGS. 2A, 2B, 2C, 2D, and/or 2E and described below is not intended to be limiting.

In some implementations, method(s) 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 200 in response to instructions stored electronically on an electronic storage medium. The one or more processing devices may include one or more devices configured through hardware, firmware, and/or software to be specifically designed for execution of one or more of the operations of method(s) 200.

FIG. 2A illustrates a method 200-a, in accordance with various aspects of the disclosure. The operations of method 200-a may be implemented using the one or more modules described above in relation to FIG. 1. Additionally, or alternatively, the operations of method 200-a may be implemented using a cookie bastion module, such as, cookie bastion module(s) 410-a, 410-b, and/or 510 described below in relation to FIGS. 4A, 4B, and/or 5, respectively.

A first operation 202 may include intercepting, from a first computing device, a request to communicate with the application. The intercepting may occur at a second computing device. For example, in FIG. 4A, the cookie bastion module 410-a (second computing device) intercepts a request from the UE 475-a (first computing device) to communicate with the app 420-a. First operation 202 may be performed by one or more hardware processors configured by machine-readable instructions including a module that is the same as or similar to request interception module 108, in accordance with one or more implementations.

A second operation 204 may include sending the request to the application from the second computing device. For example, in FIG. 4A, the cookie bastion module 410-a sends the request to the app 420-a. Second operation 204 may be performed by one or more hardware processors configured by machine-readable instructions including a module that is the same as or similar to request sending module 110, in accordance with one or more implementations.

A third operation 206 may include receiving a response from the application at the second computing device. In some examples, the response may include one or more first cookies. For example, in FIG. 4A, the app 420-a adds cookies to the response and transmits the response to the cookie bastion module 410-a. Third operation 206 may be performed by one or more hardware processors configured by machine-readable instructions including a module that is the same as or similar to response receiving module 112, in accordance with one or more implementations.

A fourth operation 208 may include caching the one or more first cookies. In FIG. 4A, the cookie bastion module 410-a caches the cookies received in the response from the app 420-a at operation 401-d. Fourth operation 208 may be performed by one or more hardware processors configured by machine-readable instructions including a module that is the same as or similar to cookie caching module 114, in accordance with one or more implementations.

A fifth operation 210 may include removing the one or more first cookies from the response. In FIG. 4A, after caching the cookies, the cookie bastion module 410-a removes the cookies received in the response from the app 420-a at operation 401-e. Fifth operation 210 may be performed by one or more hardware processors configured by machine-readable instructions including a module that is the same as or similar to cookie removing module 116, in accordance with one or more implementations.

A sixth operation 212 may include creating one or more second cookies, where the one or more second cookies are associated with the application. In FIG. 4A, after caching and removing the one or more first cookies (e.g., protected cookies), the cookie bastion module 410-a creates at least one session tracking cookie at operation 401-f. In some examples, the at least one session tracking cookie may be associated with the app 420-a. Sixth operation 212 may be performed by one or more hardware processors configured by machine-readable instructions including a module that is the same as or similar to cookie creating module 118, in accordance with one or more implementations.

A seventh operation 214 may include transmitting the response to the first computing device from the second computing device, where the response may include the one or more second cookies. At operation 401-g in FIG. 4A, the cookie bastion module 410-b relays the at least one session tracking cookie (i.e., one or more second cookies associated with the app 420-a) along with the response to the UE 475-a. Seventh operation 214 may be performed by one or more hardware processors configured by machine-readable instructions including a module that is the same as or similar to response transmittal module 120, in accordance with one or more implementations.

FIG. 2B illustrates a method 200-b, in accordance with various aspects of the disclosure.

A first operation 216 may include, after receiving a response from the application at the second computing device, detecting unauthorized access of the session information by reviewing the response for any changes to information related to the first computing device. First operation 216 may be performed by one or more hardware processors configured by machine-readable instructions including a module that is the same as or similar to response receiving module 112, in accordance with one or more implementations.

FIG. 2C illustrates a method 200-c, in accordance with various aspects of the disclosure.

A first operation 218 may include, after detecting unauthorized access of the session information, requesting additional authentication information from the first computing device. First operation 218 may be performed by one or more hardware processors configured by machine-readable instructions including a module that is the same as or similar to access detection module 122, in accordance with one or more implementations.

FIG. 2D illustrates a method 200-d, in accordance with various aspects of the disclosure.

A first operation 220 may include tracking the session with the one or more second cookies (e.g., one or more session tracking cookie(s) created at operation 401-f in FIG. 4A). First operation 220 may be performed by one or more hardware processors configured by machine-readable instructions including a module that is the same as or similar to session tracking module 124, in accordance with one or more implementations.

FIG. 2E illustrates a method 200-e, in accordance with various aspects of the disclosure.

A first operation 222 may include replacing the one or more second cookies with one of more third cookies. First operation 222 may be performed by one or more hardware processors configured by machine-readable instructions including a module that is the same as or similar to cookie replacing module 126, in accordance with one or more implementations.

A second operation 224 may include tracking the session with the one or more third cookies. For example, at operation 402-e in FIG. 4B, the cookie bastion module 410-b replaces the one or more second cookies (e.g., session tracking cookie(s) previously created at operation 401-f) with new cookies received in the app response, where the app response and new cookies are received at operation 402-d. Second operation 224 may be performed by one or more hardware processors configured by machine-readable instructions including a module that is the same as or similar to session tracking module 124, in accordance with one or more implementations.

FIG. 4A illustrates an example of a swim diagram 400-a depicting a method for abstracting session information for an application in an identity infrastructure, in accordance with various aspects of the disclosure. The operations of swim diagram 400-a may be implemented using the system 100 and/or a cookie bastion module 410-a. In some examples, the swim diagram 400-a depicts the one or more operations performed between a UE 475-a, a cookie bastion module 410-a, and an app 420-a, when an initial request is sent to the app 420-a. The initial request may originate at the UE 475-a. Specifically, but without limitation, the initial request to communicate with the app 420-a may be generated using a user agent or browser 405-a installed on the UE 475-a. While the UE 475-a is depicted as a smartphone, this is not intended to be limiting. Other types of UEs (i.e., computing devices) known in the art are contemplated in different embodiments. Some non-limiting examples of UEs include a laptop, a desktop, a NetBook, and/or a tablet computer. It should be noted that the cookie bastion module 410-a may be installed, hosted, or executed on a server (e.g., computing platform 102 in FIG. 1, computing platform or server 502-a in FIG. 5).

The method described in relation to FIG. 4A may be implemented using a computing platform (or computing system) that may be similar or substantially similar to the system 100 previously described in relation to FIG. 1. In this example, the system performing the abstraction of session information for the app 420-a is depicted as the cookie bastion module 410-a.

As noted above, the swim diagram 400-a depicts the abstraction of session information when an initial request to access a protected resource (e.g., app 420-a) is received from the browser 405-a running on the UE 475-a. Furthermore, FIG. 4B depicts the abstraction of session information when one or more subsequent requests to an app (e.g., app 420-b) are sent from a browser (e.g., browser 405-b) on a UE (e.g., UE 475-b).

In some cases, the cookie bastion module 410-a (or alternatively, the system 100) is configured to remove application session information from the browser 405-a. In some aspects, the cookie bastion module 410-a serves as a reverse proxy between the app 420-a and the browser 405-a. Further, the cookie bastion module 410-a reads the cookie information sent by the app 420-a and locally caches the cookie information. In some cases, the cookie bastion module 410-a (or alternatively, the system 100) removes the cookie information from the Hypertext Transfer Protocol (HTTP) response received from the app 420-a and creates at least one session tracking cookie for tracking the session between the browser 405-a and the app 420-a. In some examples, the cookie bastion module 410-a is configured to reinsert the cookie information previously cached in subsequent requests to the application, further described below in relation to FIG. 4B.

At first operation 401-a, the method comprises receiving a request to communicate with or access the app 420-a from a browser 405-a (e.g., a web browser running on a first computing device, such as UE 475-a). In some examples, the cookie bastion module 410-a (i.e., a second computing device) intercepts this request to the app 420-a.

At second operation 401-b, the cookie bastion module 410-a proxies the request to the app 420-a. In some examples, at third operation 401-c, the app 420-a adds one or more first cookies to the response and transmits the response to the cookie bastion module 410-a. In some cases, the one or more first cookies received from the app 420-a may be referred to as app cookies or application cookies or protected cookies to differentiate them from the one or more second cookies (e.g., session tracking cookie(s)) subsequently created at the cookie bastion module 410-a.

In some examples, at operation 401-d, the cookie bastion module 410-a caches the one or more first cookies from the response received from the app 420-a. Additionally, at operation 401-e, the cookie bastion module 410-a removes the one or more first cookies (i.e., app or protected cookies) from the response received from the app 420-a.

Next, at operation 401-f, the cookie bastion module 410-a proceeds to create one or more second cookies (also referred to as session tracking cookies), where the one or more second cookies are associated with the app 420-a. In some embodiments, each of the one or more second cookies (i.e., session tracking or bastion cookies) may comprise a cookie name/value.

In some cases, at operation 401-g, the cookie bastion module 410-a (i.e., second computing device) transmits the response to the UE 475-a, where the response comprises the one or more second cookies (i.e., session tracking cookie).

Turning now to FIG. 4B, which illustrates an example of a swim diagram 400-b depicting a method for abstracting session information for an application in an identity infrastructure, in accordance with various aspects of the disclosure. The operations of swim diagram 400-b may be implemented using the system 100 and/or a cookie bastion module 410-b. The cookie bastion module 410-b may be similar or substantially similar to the cookie bastion module 410-a described above in relation to FIG. 4A. In some examples, the swim diagram 400-b depicts the one or more operations performed between a UE 475-b, the cookie bastion module 410-b, and an app 420-b, when one or more subsequent requests are sent to access/communicate with the app 420-b. The one or more subsequent request(s) to the app 475-b may follow the initial request to the application (i.e., described above in relation to FIG. 4A). Similar to FIG. 4A, the subsequent request(s) may originate at the UE 475-b. While the UE 475-b is depicted as a smartphone, this is not intended to be limiting. Other types of UEs (i.e., computing devices) known in the art are contemplated in different embodiments. Some non-limiting examples of UEs include a laptop, a desktop, a NetBook, and/or a tablet computer. In some embodiments, the cookie bastion module 410-b may be installed, hosted, or executed on a server (e.g., computing platform 102 in FIG. 1, computing platform or server 502-a in FIG. 5).

In some examples, the cookie bastion 410-b is configured to proxy subsequent requests to access the app 420-b, as further described below. For example, at first operation 402-a, the method comprises receiving a request to access the app 420-b from the browser 405-b (or UE 475-b), where the request includes the one or more second cookies (e.g., session tracking cookie(s) created at operation 401-f in FIG. 4A). In some cases, the cookie bastion module 410-b intercepts this request including the one or more second cookies. Next, at second operation 402-b, the method comprises using the cookie bastion module 410-b to look up the one or more application/protected cookies (e.g., one or more first cookies previously received from the app 420-a at operation 401-c) that were previously cached. The cookie bastion module 410-b then adds the one or more first cookies accessed from the cache to the app request.

In some examples, at third operation 402-c, the cookie bastion module 410-b proxies the request to the app 420-b, where the request includes the one or more first cookies.

At fourth operation 402-d, the app 420-b transmits an app response, where the app response is intercepted at the cookie bastion module 410-b. In some cases, the app response includes one or more third cookies (also referred to as new cookies to distinguish them from the initial application/protected cookies and the session tracking cookies).

In some embodiments, at fifth operation 402-e, the cookie bastion module 410-b caches and removes the one or more third cookies from the app response.

Lastly, at sixth operation 402-f, the cookie bastion module 410-b forwards (or relays) the app response to the UE 475-b (or browser 405-b). In some embodiments, the final app response to the UE 475-b (or browser 405-b) contains a new set-cookie operation, for instance, if the session tracking or bastion cookies are updated.

In some embodiments, the system 100 (or the cookie bastion module(s) 410-a, 410-b) is configured to enhance session protection of web applications, such as app(s) 420, by detecting session hijacks of the one or more second cookies (i.e., session tracking or bastion cookies). In some cases, the system 100 detects a session hijack of a session tracking cookie by detecting changes in the originating internet protocol (IP) address and/or changes in the browser fingerprint information. In some instances, changes to the browser fingerprint information may include one or more changes to the information associated with the user agent (or browser), such as, but not limited to, updated browser or OS version information, and changes to device-specific information (e.g., default language, time zone). Additionally, or alternatively, the system 100 is configured to apply transparent continuous authentication to web applications (e.g., app(s) 420-a, 420-b). For example, the system 100 is configured to apply a second factor of authentication (e.g., biometric authentication in addition to username/password-based authentication, input a one-time code or password displayed on a registered user device, etc.) upon detecting changes to information related to the first computing device (e.g., UE 475 running browser 405). Some non-limiting examples of changes to the first computing device information may include changes to detected IP address and/or changes to the browser fingerprint information. In some cases, the system is configured to detect unauthorized access of the session information by reviewing the application response for any changes to information related to the first computing device. Alternatively, the system 100 prompts the user (i.e., associated with UE 475) to login to the app, such as app 420-a, again upon detecting unauthorized access of the session information.

In some embodiments, the system 100 (or cookie bastion module(s) 410) are configured to apply transparent continuous authentication to web applications, for instance, via rotation of the one or more second cookies (i.e., session tracking cookies). For example, the system 100 may periodically rotate one or more of the cookie name and value associated with the at least one session tracking cookie. In some cases, the cookie name and/or cookie value of the session tracking cookie may be valid for a brief interval (referred to as a validity interval) before being replaced. The intervals can be time-based (e.g., rotate the session tracking or bastion cookie every 30 minutes, every hour, etc.), or alternatively, based on a total number of requests (i.e., app requests). In some cases, the one or more second cookies are replaced with one or more third cookies upon at least one of (1) a time associated with a most recent request of the plurality of app requests to communicate with the app exceeds an identified time period, and (2) the most recent request of the plurality of requests to communicate with the app exceeds an identified total number of requests (e.g., rotate the cookie once 10, 100, 1000, etc., requests are exceeded). In some embodiments, continuous authentication may be handled by evaluating the data (e.g., cookies and headers) included with each request against the information known about the session from previous requests. In such cases, authentication can be continually strengthened (i.e., hardened) by rotating the session cookie and/or by including additional factors of authentication based on changes to the data between requests.

In some circumstances, the application (e.g., app 420-a, app 420-b) may not be privy to the session hijack detection and/or transparent continuous authentication applied to the application by the system 100 and/or cookie bastion module(s) 410. In accordance with aspects of the disclosure, the application may not be modified (or may have minimal modifications) and may have minimal to no awareness of the additional protection being added to the application.

FIG. 5 illustrates an example of an identity infrastructure 500, according to various aspects of the disclosure. The identity infrastructure 500 comprises a UE 575 associated with a user 595, a server 502-a comprising a cookie bastion module 510, and an identity provider 515 comprising a server 502-b and an app 520. The UE 575 may be similar or substantially similar to the UEs 475-a, 475-b described above in relation to FIGS. 4A-B. Additionally, the server 502-a may be similar or substantially similar to the system 100 (or the computing platform 102) described above in relation to FIG. 1. The app 520 may implement one or more aspects of the app(s) 420-a and/or 420-b described above in relation to FIGS. 4A and/or 4B, respectively. As shown, the UE 575 may be in communication with the server 502 using a first communication link 555-a, and the server 502-a may be in further communication with one or more of the identity provider 515, the app 520, and the server 502-b using a second communication link 555-b. The communication links 555-a, 555-b may be examples of bi-directional communication links and may be implemented using wired or wireless techniques (e.g., ethernet, Wi-Fi, cellular or mobile data, Bluetooth, to name a few). In some cases, the identity infrastructure 500 is configured to support any of the method(s) described herein, including at least method(s) 200 described in relation to FIGS. 2A-E and the method(s) described in relation to swim diagrams 400-a, 400-b in FIGS. 4A-B.

In some embodiments, the identity provider 515 comprises an attributes system 526 linked or associated with a LDAP 533 for gathering identity attributes, an access system 523 supporting an Identity as a Service (IDaaS) 531 for authorization, and an authenticate system 521 supporting MFA 529. In some cases, the access system 523 may enforce decisions about authentication and authorization set by the IDaaS 531. Furthermore, the identity provider 515 may be used to control user access to one or more app(s) 520. The various identity infrastructure elements (e.g., identity provider 515, cookie bastion module 510, servers 502-a and 502-b, UE 575) may communicate using communication links 555. In some examples, the cookie bastion module 510 (or alternatively, the server 502-a) serves as a reverse proxy between the UE 575 and the app 520.

In some embodiments, the UE 575 may transmit a request to access the app 520 using communication link 555-a, where the request is intercepted at the server 502-a. In some cases, the app 520 may be associated with the identity provider 515 and an optional datastore (not shown). The optional datastore may include or store user credentials, such as, but not limited to, legacy user credentials. In some examples, the datastore may comprise a legacy identity and access management (IAM) system datastore associated with the app 520. Furthermore, the datastore may comprise LDAP 533 and a database (optional). In some implementations, requesting to access the application may include one of an initial request to access the app (i.e., described above in relation to FIG. 4A) or a subsequent request to access the app (i.e., described above in relation to FIG. 4B). If the request comprises an initial request, the cookie bastion module 510 (or server 502-a) may perform one or more of the operations described above in relation to FIG. 4A. Alternatively, if the request comprises a subsequent request, the cookie bastion module 510 (or server 502-b) may perform one or more of the operations described above in relation to FIG. 4B.

As noted above, identity information may comprise identity data, identity metadata, structure and/or contents of identity sessions, as well as configuration and deployment information for software and hardware entities of the identity provider 515. In some cases, when the user 595 is attempting to access the app 520, the user 595 may provide identity data, including one or more of a username, a password, biometrics information (e.g., fingerprint, iris or retina scan, voice input, etc.), a unique identifier or pin, etc. In some cases, a login/request may also include a request to access the app 520.

In some cases, for instance, during an initial request to the app, the cookie bastion module 510 or server 502-a may also include the identity data provided by the user 595 to the identity provider 515 or server 502-b. In such cases, the user input (e.g., identity data) may be relayed to any one of the runtime systems (e.g., device system 522, attributes system 526, access system 523, authenticate system 521, risk system 524).

As an example, the identity data (also referred to as original authentication information, in some examples) provided by the user 595 may be sent to one or more identity infrastructure elements, such as the authenticate system 521, the access system 523, the attributes system 526, the device system 522 (shown as optional by the dashed lines), and/or the risk system 524 (optional) associated with the identity provider 515 (e.g., a legacy IAM system). In some cases, the identity dataflow may be sent to other systems not identified herein. In some cases, the authenticate system 521 may support MFA 529, the access system 523 may support identity as a service (IDaaS) 531 for authorization, and the attributes system 526 may be linked or associated with a LDAP 533 for gathering identity attributes. In some implementations, the access system 523 may enforce decisions about authentication and authorization set by the IDaaS system 531.

In the example shown, the optional device system 522 may be linked or associated with a device API 527, which may perform device verification, and the risk system 524 may be linked or associated with a risk API 537, which may retrieve a threat or risk score. In some embodiments, the risk API 537 and the device API 527 may link the risk system 524 and/or device system 522, respectively, to one or more applications (not shown), where the one or more applications may be third-party applications. In some cases, the one or more third party applications may be executed or hosted on another server (not shown). For instance, the device 46I system 522 may interact with a third-party device verification application by making an API call using device API 527. The third-party device verification application may then process the information (e.g., a phone number, mobile device identifier, such as International Mobile Equipment Identity (IMEI), Mobile Equipment Identifier (MEID), Electronic Serial Number (ESN), International Mobile Subscriber Identity (IMSI), etc., and Media Access Control (MAC) address, to name a few non-limiting examples) received from the device system 522 (via the device API 527) and relay a response (e.g., Verified or Not verified, 1 or 0, Yes or No, etc.) to the device system 522. In some cases, the device system 522 may determine, from the response, if the UE 575 associated with the login/request is a recognized device or an unknown device. In some cases, the risk system 524 may also interact with a third-party risk verification application via the risk API 537. In some embodiments, the third-party risk and verification applications may be executed or hosted on the same or different third-party server(s). In some cases, device verification may serve as an added level of security (i.e., in addition to a username and password, for instance) and may be used to verify that the login/request is coming from a recognized device (e.g., mobile device, laptop, computer, etc.) associated with an authorized user. In some cases, device verification may comprise transmitting a verification code over text (SMS), a phone call, an app, etc., to a recognized device associated with the user. The device system 522 may verify the device (i.e., UE 575) from which the login/request was received upon the user 595 inputting the same verification code. In some cases, the threat or risk score may be associated with a perceived or estimated threat level (e.g., for a user's identity), and may be based on one or more factors, including, but not limited to, time of day, day of week, geographic data, and/or IP address. For instance, a higher risk score may be assigned when the login/request is during non-working hours (e.g., 3 AM) as compared to during working hours (e.g., 11 am). In another example, a lower risk score may be assigned when the login/request is from a known IP address as opposed to an unknown IP address. In yet another example, a higher risk score may be assigned when the login/request is from a geographic region (e.g., city, state, country, etc.) that the user has never logged in from before.

In some cases, the risk system 524 may authorize or flag the login/request based in part on comparing the retrieved risk or threat score to a threshold. In one non-limiting example, the login/request to access the app 520 may be denied based on the risk score exceeding the threshold (e.g., if it is determined that the user data is compromised based on validating one or more of the user identifier, the user credentials information, and any other identity data for the user). In another example, the user 595 requesting the login may be prompted to change their password (e.g., if the authentication policy states that the password should be updated every 3 months, 6 months, etc.) based on receiving a link or code on a registered device (e.g., maybe the same or different UE). In this case, the user 595 may need to first click the link or input the code received on their registered device (e.g., a smartphone associated with the user 595) and then proceed to update their password. The cookie bastion module 510 (or alternatively, the identity provider 515) may then prompt the UE 595 to restart the login process via the one or more runtime systems (e.g., authenticate system 521, access system 523, etc.). Alternatively, if the risk or threat score is under a threshold, the login may be successful and an application session may be initiated (e.g., the UE 575 may display a Welcome Screen with one or more links to access different apps or resources, including app 520).

In some embodiments, the server 502-a (or a module of the server, such as the cookie bastion module 510 or a discovery module) may monitor the identity dataflow as it passes through the various identity infrastructure elements or runtime systems and determine the information used to establish an identity session and gain access to the app 520. In some cases, the server 502-a may also identify where unsuccessful requests are routed to (e.g., routed to attributes system 526 so that user password can be updated). In some cases, an application or identity session may refer to a temporary and interactive information interchange between two or more communicating devices (e.g., UE 575 associated with the login/request and the server 502-b hosting the app 520). Further, an established session (e.g., an identity session, an application session) may be a prerequisite for performing a connection-oriented communication. In some cases, a session may be initiated or established before data is transferred. As described above, initiation of the application or identity session may comprise displaying a successful login screen or welcome screen with one or more links to resources or apps authorized for use by the user 595, for instance, which may be indicative of a connection between the UE 575 and the server 502-b hosting the app 520.

It should be noted that the identity dataflow may interact with any of the runtime systems illustrated in FIG. 5, and in any order. In some other cases, the identity dataflow may interact with different runtime systems in parallel (e.g., authenticate system 521 and device system 522 simultaneously).

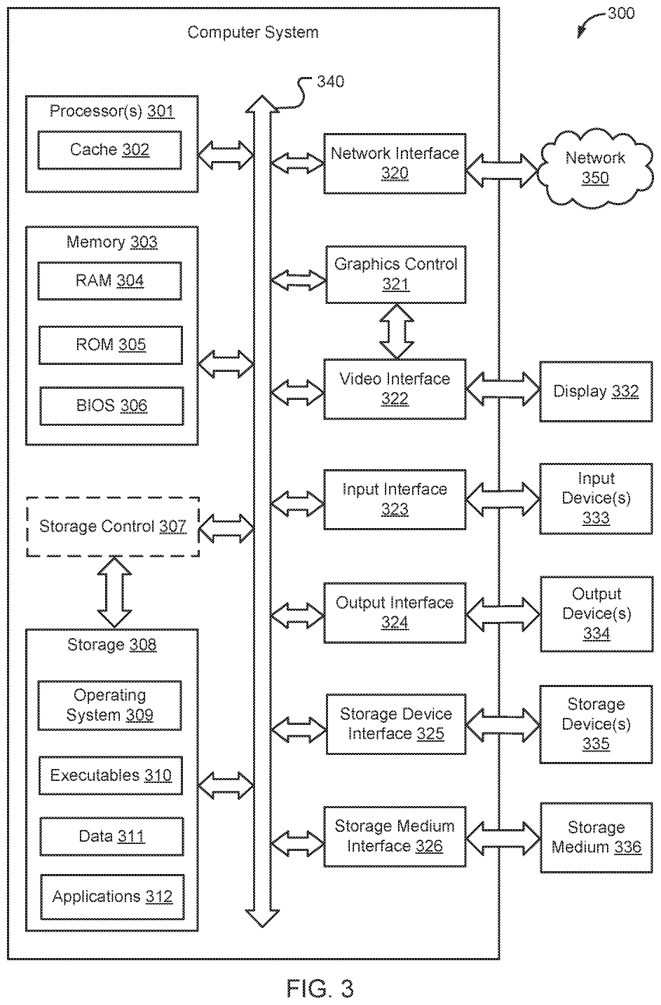

FIG. 3 illustrates a diagrammatic representation of one embodiment of a computer system 300, within which a set of instructions can execute for causing a device to perform or execute any one or more of the aspects and/or methodologies of the present disclosure. The components in FIG. 3 are examples only and do not limit the scope of use or functionality of any hardware, software, firmware, embedded logic component, or a combination of two or more such components implementing particular embodiments of this disclosure. Some or all of the illustrated components can be part of the computer system 300. For instance, the computer system 300 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 300 includes at least a processor 301 such as a central processing unit (CPU) or a graphics processing unit (GPU) to name two non-limiting examples. Any of the subsystems described throughout this disclosure could embody the processor 301. The computer system 300 may also comprise a memory 303 and a storage 308, both communicating with each other, and with other components, via a bus 340. The bus 340 may also link a display 332, one or more input devices 333 (which may, for example, include a keypad, a keyboard, a mouse, a stylus, etc.), one or more output devices 334, one or more storage devices 335, and various non-transitory, tangible computer-readable storage media 336 with each other and/or with one or more of the processor 301, the memory 303, and the storage 308. All of these elements may interface directly or via one or more interfaces or adaptors to the bus 340. For instance, the various non-transitory, tangible computer-readable storage media 336 can interface with the bus 340 via storage medium interface 326. Computer system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 301 (or central processing unit(s) (CPU(s))) optionally contains a cache memory unit 302 for temporary local storage of instructions, data, or computer addresses. Processor(s) 301 are configured to assist in execution of computer-readable instructions stored on at least one non-transitory, tangible computer-readable storage medium. Computer system 300 may provide functionality as a result of the processor(s) 301 executing software embodied in one or more non-transitory, tangible computer-readable storage media, such as memory 303, storage 308, storage devices 335, and/or storage medium 336 (e.g., read only memory (ROM)). Memory 303 may read the software from one or more other non-transitory, tangible computer-readable storage media (such as mass storage device(s) 335, 336) or from one or more other sources through a suitable interface, such as network interface 320. Any of the subsystems herein disclosed could include a network interface such as the network interface 320. The software may cause processor(s) 301 to carry out one or more processes or one or more steps of one or more processes described or illustrated herein. Carrying out such processes or steps may include defining data structures stored in memory 303 and modifying the data structures as directed by the software. In some embodiments, an FPGA can store instructions for carrying out functionality as described in this disclosure. In other embodiments, firmware includes instructions for carrying out functionality as described in this disclosure.

The memory 303 may include various components (e.g., non-transitory, tangible computer-readable storage media) including, but not limited to, a random-access memory component (e.g., RAM 304) (e.g., a static RAM “SRAM”, a dynamic RAM “DRAM, etc.), a read-only component (e.g., ROM 303), and any combinations thereof. ROM 303 may act to communicate data and instructions unidirectionally to processor(s) 301, and RAM 304 may act to communicate data and instructions bidirectionally with processor(s) 301. ROM 303 and RAM 304 may include any suitable non-transitory, tangible computer-readable storage media. In some instances, ROM 303 and RAM 304 include non-transitory, tangible computer-readable storage media for carrying out any of the method(s) disclosed herein, including at least in relation to FIGS. 2-6. In one example, a basic input/output system (BIOS) 306, including basic routines that help to transfer information between elements within computer system 300, such as during start-up, may be stored in the memory 303.

Fixed storage 308 is connected bi-directionally to processor(s) 301, optionally through storage control unit 307. Fixed storage 308 provides additional data storage capacity and may also include any suitable non-transitory, tangible computer-readable media described herein. Storage 308 may be used to store operating system 309, EXECs 310 (executables), data 311, API 312, and the like. Often, although not always, storage 308 is a secondary storage medium (such as a hard disk) that is slower than primary storage (e.g., memory 303). Storage 308 can also include an optical disk drive, a solid-state memory device (e.g., flash-based systems), or a combination of any of the above. Information in storage 308 may, in appropriate cases, be incorporated as virtual memory in memory 303.

In one example, storage device(s) 335 may be removably interfaced with computer system 300 (e.g., via an external port connector (not shown)) via a storage device interface 325. Particularly, storage device(s) 335 and an associated machine-readable medium may provide nonvolatile and/or volatile storage of machine-readable instructions, data structures, program modules, and/or other data for the computer system 300. In one example, software may reside, completely or partially, within a machine-readable medium on storage device(s) 335. In another example, software may reside, completely or partially, within processor(s) 301.

Bus 340 connects a wide variety of subsystems. Herein, reference to a bus may encompass one or more digital signal lines serving a common function, where appropriate. Bus 340 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 300 may also include an input device 333. In one example, a user of computer system 300 may enter commands and/or other information into computer system 300 via input device(s) 333. Examples of an input device(s) 333 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 333 may be interfaced to bus 340 via any of a variety of input interfaces 323 (e.g., input interface 323) including, but not limited to, serial, parallel, game port, USB, FIREWIRE, THUNDERBOLT, or any combination of the above.

In particular embodiments, when computer system 300 is connected to network 350, computer system 300 may communicate with other devices, such as mobile devices and enterprise systems, connected to network 350. Communications to and from computer system 300 may be sent through network interface 320. For example, network interface 320 may receive incoming communications (such as requests or responses from other devices) in the form of one or more packets (such as Internet Protocol (IP) packets) from network 330, and computer system 300 may store the incoming communications in memory 303 for processing. Computer system 300 may similarly store outgoing communications (such as requests or responses to other devices) in the form of one or more packets in memory 303 and communicated to network 350 from network interface 320. Processor(s) 301 may access these communication packets stored in memory 303 for processing.

Examples of the network interface 320 include, but are not limited to, a network interface card, a modem, and any combination thereof. Examples of a network 350 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 350, may employ a wired and/or a wireless mode of communication. In general, any network topology may be used.

Information and data can be displayed through a display 332. Examples of a display 332 include, but are not limited to, a liquid crystal display (LCD), an organic liquid crystal display (OLED), a cathode ray tube (CRT), a plasma display, and any combinations thereof. The display 332 can interface to the processor(s) 301, memory 303, and fixed storage 308, as well as other devices, such as input device(s) 333, via the bus 340. The display 332 is linked to the bus 340 via a video interface 322, and transport of data between the display 332 and the bus 340 can be controlled via the graphics control 321.

In addition to a display 332, computer system 300 may include one or more other peripheral output devices 334 including, but not limited to, an audio speaker and/or a printer. Such peripheral output devices may be connected to the bus 340 via an output interface 324. Examples of an output interface 324 include, but are not limited to, a serial port, a parallel connection, a USB port, a FIREWIRE port, a THUNDERBOLT port, and any combinations thereof.

In addition, or as an alternative, computer system 300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components, such as those in an FPGA, once programmed with the software module.

It is contemplated that one or more of the components or subcomponents described in relation to the computer system 300 shown in FIG. 3 such as, but not limited to, the network 350, processor 301, memory, 303, etc., may comprise a cloud computing system. In one such system, front-end systems such as input devices 333 may provide information to back-end platforms such as servers (e.g., computer systems 300) and storage (e.g., memory 303). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for abstracting session information for an application in an identity infrastructure, the system comprising:
one or more hardware processors configured by machine-readable instructions to:
intercept, from a first computing device, a request to communicate with the application, wherein the intercepting occurs at a second computing device;
send the request to the application from the second computing device;
receive a response from the application at the second computing device, wherein the response comprises one or more first cookies;
cache the one or more first cookies;
remove the one or more first cookies from the response;
create one or more second cookies, wherein the one or more second cookies are associated with the application; and
transmit the response to the first computing device from the second computing device, wherein the response comprises the one or more second cookies.

2. The system of claim 1, wherein the one or more hardware processors are further configured by machine-readable instructions to:
after receiving a response from the application at the second computing device, detect unauthorized access of the session information by reviewing the response for any changes to information related to the first computing device.

3. The system of claim 2, wherein the information related to the first computing device comprises at least one of a first computing device internet protocol (IP) address and first computing device browser fingerprint information.

4. The system of claim 2, wherein the one or more hardware processors are further configured by machine-readable instructions to:
after detecting unauthorized access of the session information, request additional authentication information from the first computing device.

5. The system of claim 4, wherein,
the request to communicate with the application comprises original authentication information; and
the additional authentication information comprises at least one of one or more additional factors of authentication and the original authentication information provided in the request to communicate with the application.

6. The system of claim 1, wherein the one or more hardware processors are further configured by machine-readable instructions to track the session with the one or more second cookies.

7. The system of claim 6, wherein the one or more hardware processors are further configured by machine-readable instructions to:
replace the one or more second cookies with one of more third cookies;
track the session with the one or more third cookies.

8. A method for abstracting session information for an application in an identity infrastructure, the method comprising:
intercepting, from a first computing device, a request to communicate with the application, wherein the intercepting occurs at a second computing device;
sending the request to the application from the second computing device;
receiving a response from the application at the second computing device, wherein the response comprises one or more first cookies;
caching the one or more first cookies;
removing the one or more first cookies from the response;
creating one or more second cookies, wherein the one or more second cookies are associated with the application; and
transmitting the response to the first computing device from the second computing device, wherein the response comprises the one or more second cookies.

9. The method of claim 8, further comprising, after receiving a response from the application at the second computing device, detecting unauthorized access of the session information by reviewing the response for any changes to information related to the first computing device.

10. The method of claim 9, wherein the information related to the first computing device comprises at least one of a first computing device internet protocol (IP) address and first computing device browser fingerprint information.

11. The method of claim 9, further comprising, after detecting unauthorized access of the session information, requesting additional authentication information from the first computing device.

12. The method of claim 11, wherein,
the request to communicate with the application comprises original authentication information; and
the additional authentication information comprises at least one of one or more additional factors of authentication and the original authentication information provided in the request to communicate with the application.

13. The method of claim 8, further comprising tracking the session with the one or more second cookies.

14. The method of claim 13, further comprising:
replacing the one or more second cookies with one of more third cookies; and
tracking the session with the one or more third cookies.

15. The method of claim 14, wherein,
the request to communicate with the application comprises a plurality of requests to communicate with the application; and
the one or more second cookies are replaced with the one or more third cookies upon at least one of,
a time associated with a most recent request of the plurality of requests to communicate with the application exceeds an identified time period; and
the most recent request of the plurality of requests to communicate with the application exceeds an identified total number of requests.

16. A non-transient computer-readable storage medium having instructions embodied thereon, the instructions being executable by one or more processors to perform a method for abstracting session information for an application in an identity infrastructure, the method comprising:
intercepting, from a first computing device, a request to communicate with the application, wherein the intercepting occurs at a second computing device;
sending the request to the application from the second computing device;
receiving a response from the application at the second computing device, wherein the response comprises one or more first cookies;
caching the one or more first cookies;
removing the one or more first cookies from the response;
creating one or more second cookies, wherein the one or more second cookies are associated with the application; and
transmitting the response to the first computing device from the second computing device, wherein the response comprises the one or more second cookies.

17. The computer-readable storage medium of claim 16, wherein the method further comprises, after receiving a response from the application at the second computing device, detecting unauthorized access of the session information by reviewing the response for any changes to information related to the first computing device.

18. The computer-readable storage medium of claim 17, wherein the information related to the first computing device comprises at least one of a first computing device internet protocol (IP) address and first computing device browser fingerprint information.

19. The computer-readable storage medium of claim 17, wherein the method further comprises, after detecting unauthorized access of the session information, requesting additional authentication information from the first computing device.

20. The computer-readable storage medium of claim 16, further comprising tracking the session with the one or more second cookies.
